(19) United States
(12) Patent Application Publication
(10) Pub. No.: US 2005/0092192 A1
(43) Pub. Date: May 5, 2005

(54) Heated merchandiser for bread and the like

(76) Inventor: Rick A. Barker, Rockford, MI (US)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 10/698,922

(22) Filed: Oct. 31, 2003

(51) Int. Cl. A23C 15/04

(52) U.S. Cl. 99/483

(57) ABSTRACT

A merchandiser for elongate loaves of fresh baked bread includes an open rack having a generally vertically extending rear wall, front wall, and side walls. The open rack further contains a bottom wall having at least one opening to permit the vertical flow of air therethrough, and is configured to support thereon the ends of the elongate loaves of bread in a generally vertical, freestanding, side by side relationship. The merchandiser includes a base which supports the open rack, and has a generally enclosed interior with a heater disposed therein for selectively heating the air, whereby the heated air flows upwardly through the opening in the bottom wall to warm the vertically stacked loaves of bread to maintain the fresh baked smell and feel of the bread loaves.

### BACKGROUND

The present invention relates to merchandisers and more particularly to bread merchandisers for elongate loaves of fresh baked bread and the like.

Bread racks or bread displays as they are sometimes called, are used within retail establishments such as grocery stores, supermarkets and the like. These racks are used to store and display ordinary or commercially available bread. That is, bread that is made off-site, baked days or even weeks before by various suppliers and is generally mass produced. These breads are typically displayed within the grocery store on simple metal racks which support the loaves of bread in a generally horizontal orientation.

Modern grocers are keenly aware of profit margins and are constantly looking for new food articles, as well as improved merchandising techniques in order to increase profits. Specialty goods, that is to say goods that are either hard to find or made on site, have become quite popular in this respect, and many grocers are establishing an in-store deli and/or bakery section in an effort to provide its customers with these specialty items and freshly baked goods.

One such specialty good which has seen an increase in sales is freshly baked bread. Additionally, since the bakery area is an ideal location for the baking and sale of these breads, grocers are increasingly turning over oven time to create these specialty loaves of bread. Typically, these loaves of bread are baked in small batches, utilize no preservatives, and are sold within hours of the baking process.

In addition to new food articles, the modern grocer is also looking to develop new ways of merchandising these articles in an effort to increase sales. However, the methods heretofore have been confined to shelving units and baskets. These racks or baskets are usually located in the bakery section in an attempt to entice the customer into purchasing the bread, as the bakery section automatically suggests that the product is freshly baked. However, the floor space within the grocery store is always at a premium. This is especially true with regard to the bakery section, as this section is typically confined to a relatively small area in comparison to the wide variety of baked products which it offers. Nevertheless, when the freshly baked bread is removed from the bakery environment and moved into other areas of the store, sales of the bread typically diminish. This is normally attributed to the removal of the bread from the bakery section because the customer loses the suggestion or impression that the bread is freshly baked.

Thus, a system having the aforementioned advantages and solving the aforementioned problems is desired.

### SUMMARY OF THE PRESENT INVENTION

One aspect of the present invention is a merchandiser for elongate loaves of fresh baked bread and the like, which includes an open rack having a generally vertical rear wall, front wall and a pair of side walls disposed on opposite sides thereof. The open rack includes a generally horizontal bottom wall disposed between the rear, front and side walls along a lower portion thereof. The bottom wall also includes at least one opening which permits the vertical flow of air therethrough and is configured to abuttingly support the ends of the bread loaves, such that a plurality of the bread loaves are removably retained between the walls of the open rack in a generally vertical, freestanding, side by side relationship. A base is also provided, having a lower portion shaped to support the base on a floor surface and an upper portion which supports the open rack. The base further includes a generally enclosed interior wherein a heater is disposed which selectively heats the air within the enclosed interior. The heated air flows upwardly, through the opening in the bottom wall of the open rack, through the open rack and along opposite sides of the vertically stacked bread loaves to maintain the fresh baked smell and feel of the bread loaves.

Another aspect of the present invention is to provide a method of merchandising elongate loaves of fresh baked bread and the like which includes providing a merchandiser having an open rack with a generally vertical rear wall, a generally vertical front wall, a pair of generally vertical side walls and a bottom wall with at least one opening to permit the vertical flow of air. Additionally, a base is provided having a generally closed interior which is shaped to support the open rack wherein a heater is disposed. A plurality of fresh baked loaves of bread are provided and stacked vertically in the open rack, and the merchandiser is positioned at a location which is visible to the customer. The heater is actuated to maintain the temperature of the loaves of bread at a temperature not to exceed 120° in order to retain the fresh baked smell and feel of the bread loaves.

These and other advantages of the invention will be further understood and appreciated by those skilled in the art by reference to the following written specification, claims and appended drawings.

### BRIEF DESCRIPTION OF DRAWINGS

FIG. 1 is a perspective view of a merchandiser in accordance with the present invention;

FIG. 2 is a sectional view of the merchandiser of FIG. 1, taken along line II-II;

FIG. 3 is a sectional view of the merchandiser of FIG. 1, taken along line III-III and positioned adjacent a checkout counter; and

FIG. 4 is a second embodiment of a merchandiser in accordance with the present invention.

### DETAILED DESCRIPTION OF PREFERRED EMBODIMENTS

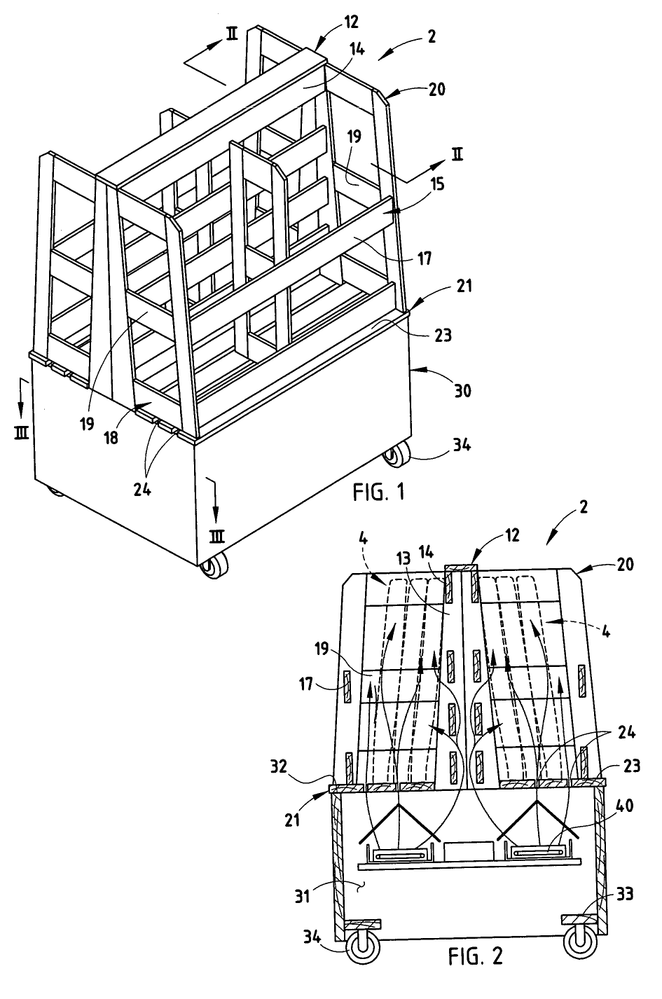

For the purposes of the description herein, the terms “upper,” “lower,” “right,” “left,” “rear,” “front,” “vertical,” “horizontal” and derivatives thereof shall relate to the invention as oriented in FIG. 1. However, it is to be understood that the invention may assume various alternative orientations and step sequences, except where expressly specified to the contrary. It is to be understood that the specific devices and processes illustrated in the attached drawings, and described in the following specification, are exemplary embodiments of the inventive concepts defined in the appended claims. Hence, specific dimensions and other physical characteristics relating to the embodiments disclosed herein are not to be considered as limiting, unless the claims expressly state otherwise.

The reference numeral 2 (FIG. 1) generally designates a heated merchandiser embodying the present invention for the display of elongated or baguette shaped loaves of bread. In the illustrated example, a double sided merchandiser 2 for elongate loaves of freshly baked breads and the like are illustrated. Merchandiser 2 includes an open rack 10 having a generally vertical extending rear wall 12 and a generally vertically extending front wall 15 which is spaced apart a predetermined distance from rear wall 12. Open rack 10 includes a first and second side wall 18 and 20, respectively, along opposite sides and a generally horizontally extending bottom wall 21. Bottom wall 21 is positioned horizontally between rear wall 12, side walls 18 and 20, and front wall 15 along lower portions thereof. Bottom wall 21 further includes at least one opening which permits the vertical flow of air therethrough. Additionally, bottom wall 21 is configured to support the elongate loaves of bread in such a way that a plurality of the bread loaves are removably retained between rear wall 12, front wall 15 and both side walls in a generally vertical, freestanding side by side relationship (see FIG. 4). Merchandiser 2 also includes a base 30 which has an upper portion 32 which supports open rack 10 and a lower portion 33 shaped to support base 30 and associated open rack 10 on a floor surface. Base 30 further includes a heater 40 disposed in the generally enclosed interior thereof which selectively heats the air enclosed therein, such that the heated air flows upwardly, through the opening in bottom wall 21 of open rack 10, through open rack 10 and along opposite sides of the vertically stacked bread loaves to maintain the fresh baked smell and feel of the bread loaves.

In the illustrated example, the bread used with the merchandiser is freshly baked elongated or baguette shaped loaves of bread and is generally well known in the art. This shape of bread is common with French or Italian bread, however, any bread with an elongated shape may be used as long as it is capable of being stored vertically. Typically, this will require a bread with a sufficiently hard crust to allow for vertically oriented storage. Further, these bread loaves are typically baked in relatively small batches, utilize little to no preservatives, and are meant to be sold within hours of the baking process, hence the term freshly baked. The packaging for this bread is frequently a paper bag. This packaging allows some of the moisture in the fresh baked bread to escape, thereby insuring that the crust remains hard or crisp while simultaneously providing a barrier against outside contaminants. Other forms of packaging may be used though, as requirements dictate. As recognized by those skilled in the art, the elongate and baguette shaped freshly baked loaves of bread illustrated in FIG. 4 are different from commercially available, mass produced soft breads, which are usually wrapped in plastic bags and stored horizontally.

More particularly, vertically extending rear wall 12 of open rack 10 defines a plurality of openings 13 as best viewed in FIG. 2. Characteristically, these openings become wider, with respect to the vertical spacing, as openings 13 progress vertically upward. A plurality of slats 14 define the plurality of openings 13 and in one embodiment are made of wood. However, this is only one embodiment and other configurations and materials may be used to create slats 14 or openings 13.

Vertically extending front wall 15 is spaced apart a predetermined distance from rear wall 12. Front wall 15 is generally constructed from at least one horizontally extending slat 17 vertically positioned at a height that is substantially less than the height of rear wall 12. This positioning allows easy withdrawal of the bread loaves from open rack 10. In one embodiment, horizontally extending slat 17 is made of wood and is spaced at approximately the midpoint of front wall 15. However, this example is not meant to be limiting and a plurality of slats 17 may be used vertically, horizontally or in any other configuration as requirements dictate and further, may be disposed at any height. Moreover, slat 17 may be fabricated from other materials in addition to wood. In one embodiment, two slates are used to create front 15, one at the bottom of front wall 15 and the other at approximately its midpoint.

First side wall 18 and second side wall 20 are disposed vertically between rear wall 12 and front wall 15 on opposite ends thereof. Side walls 18 and 20 are generally constructed from at least one horizontally extending slat which is vertically positioned at a preferred height. In one embodiment, three horizontally extending slats 19 are made of wood and spaced vertically equidistant, with one slat 19 disposed at approximately the midpoint of walls 18 and 20. However, as described above, this example is not meant to be limiting and any number of slats 19 may be used vertically, horizontally or in any other configuration as the requirements dictate. Further, slats 19 may be disposed at any height and fabricated from other materials.

The rear wall 12, front wall 15, side walls 18 and 20 and bottom wall 21 work in conjunction to create an enclosure which is relatively open in character and defines open rack 10. Bottom wall 21 includes the at least one opening which permits the vertical flow of air therethrough (as described below) and is configured to support the ends of the elongate loaves of bread which are removably retained within open rack 10. In one embodiment, bottom wall 21 is fabricated from a plurality of laterally spaced apart, horizontally extending slats 23 wherein the opening comprises a plurality of elongate slots 24 defined between slats 23. Although any material may be used to manufacture slats 23, in the preferred embodiment wooden slats are used. Additionally, the spacing of slats 23 may vary depending upon specific requirements.

Merchandiser 2 includes base 30 which supports bottom wall 21, thereby supporting open rack 10. Base 30 has a generally enclosed interior 31 and includes an upper portion 32 and a bottom portion 33. In one embodiment, upper portion 32 is generally open and base 30 is box-shaped and made of wood. Again however, other materials and shapes may used to fit specific requirements. Additionally, bottom 33 is generally configured to support base 30 from a floor surface and may include a plurality of wheels 34 which rollingly support merchandiser 2. Still further, disposed within enclosed interior 31 is heater 40.

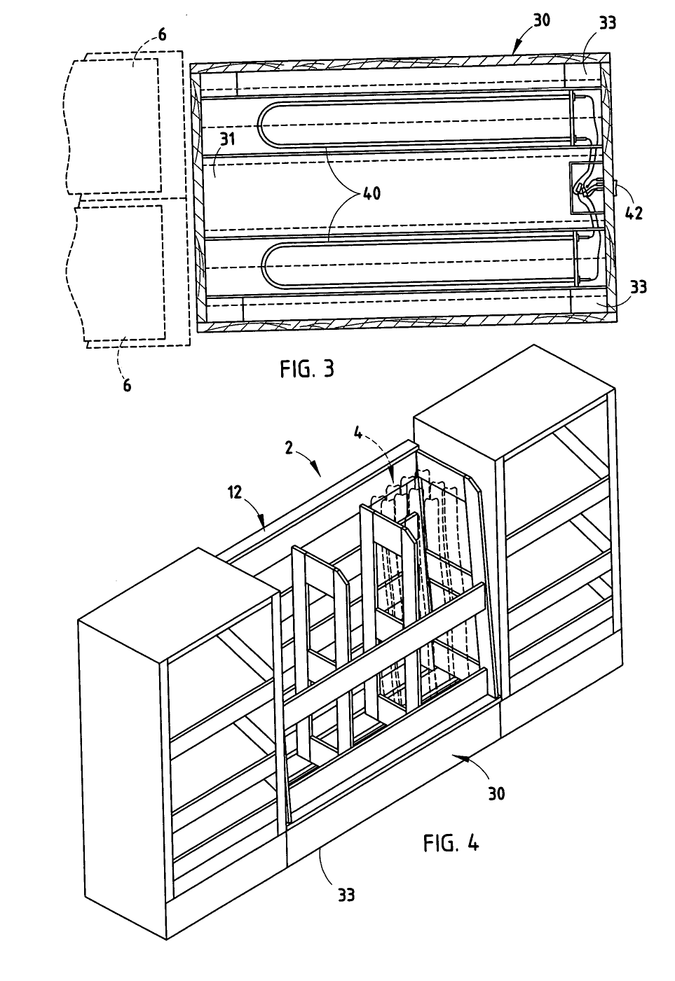

As illustrated in FIG. 3, at least one heater 40 is disposed within enclosed interior 31 of base 30. Heater 40 may be of any type which is capable of slightly warming the air within enclosed interior 31. Heater 40 is used to heat the air within enclosed interior 31, thereby inducing the warm air to rise up and through openings 24. Heater 40 raises the temperature of the air within enclosed interior 31 to such a degree that the air rising through slots 24 in bottom wall 20 and slots 13 in rear wall 12 is heated to a temperature of between about 80° and 120° F., more preferably between about 85° and 110° F. and most preferably between about 90° and 100° F. Any type of heater that meets these requirements may be used. However, in the preferred embodiment, a pair of U-shaped electrically resistant heaters are utilized. Additionally, although a fan may be used to circulate or promote airflow through the various slots 24, in the preferred embodiment, no fan is used and the heated air is moved through a convective process. Switch 42 is disposed on base 30 in any convenient location and controls the operation of heaters 40. Further, it is envisioned that an electronic thermostat may be used to regulate the operation of heaters 40 in order to ensure the proper temperature requirements are met.

As illustrated in FIG. 4, a second embodiment is shown which utilizes the same features and characteristics as the first embodiment. However, instead of the merchandiser being rollingly supported, base 30 of merchandiser 2 is configured to be supported directly from lower portion 33 of base 30. For example, merchandiser 2 may be disposed between other shelving units. Further, the merchandiser may be supported off of the floor surface, for example, on a counter or shelf surface.

As best illustrated in FIG. 2, the operation of merchandiser 2 is such that heater 40, when turned on, will heat the air within enclosed area 31 of base 30 and through convection the heated air will rise towards top 32 of base 30 and will escape either through slots 24 or slots 13 of open rack 10. In one embodiment, slots 24 are evenly spaced to insure even heat distribution along the bottom of the loaves of bread supported on slats 23. However, in order to insure a more even heat distribution, slots 13 increase in vertical separation as slats 14 progress vertically upward in order to yield a more even heat distribution along rear wall 12 and correspondingly along the bread loaves. In use then, as the heated air rises through slots 13 and 24, the plurality of elongate loaves of freshly baked bread, while being retained within open rack 10, are warmed to a slightly higher temperature.

An associated method of merchandising elongate loaves of fresh baked bread and the like includes vertically stacking a plurality of loaves of freshly baked bread 4 in open rack 10 of merchandiser 2, as shown in FIG. 2. The merchandiser can then be positioned in a location which is visible to the customer. In the embodiment illustrated in FIG. 4, the merchandiser 2 is positioned immediately before the checkout lanes 6 of a grocery store or supermarket, as a point of sale display, giving the customer the impression, more particularly the feeling or sensation, that the loaves of bread have been recently removed from the oven and enticing the customers to purchase the fresh, warm bread. In a preferred embodiment, a double sided merchandiser is used and is positioned between two checkout lanes, thereby serving both lanes with a single unit. The merchandiser is then turned on and the loaves of freshly baked bread are heated, or more appropriately, are able to retain some of the heat absorbed during the baking process by heater 40. Heater 40 will regulate the temperature of the air within base 30 so that the freshly baked bread is kept at a temperature of between about 80° and about 120° F., more preferably between about 85° and 110° F. and most preferably between about 90° and 100° F. in order to maintain the fresh baked smell and feel of the bread loaves.

The filling or refilling of the freshly baked bread is made easier due to the relatively open vertical front wall 15. This allows the bread to be easily inserted into open rack 10 and therefore easily restocked. Simultaneously, front wall 15 allows for the bread to be easily removed by the customer. When merchandiser 2 is to be restocked, the bread may be brought to the location of the merchandiser, for example, at the checkout lanes. Alternatively, the merchandiser may be moved, or in a preferred embodiment, rolled to a convenient location for restocking. This location may be, for example, the bakery.

By increasing the temperature of the fresh baked bread, the shelf life is accordingly decreased. Therefore, the temperature that the freshly baked bread is kept at is required to be relatively low. Merchandiser 2 is designed to maintain the warmth of the freshly baked bread only slightly higher than room temperature. For example, the freshly baked bread may maintain the already oven heated fresh bread at a preferred temperature of between about 90° to about 100° F., giving the customer the impression that the bread was very recently removed from a bakery oven. Because of these low temperatures and lack of other mechanical or electrical parts, merchandiser 2 is made from a wood material. This provides a softer, more boutique like look to the merchandiser, rather than the harsh characteristics of stainless steel which is typical of heating and steaming ovens which are in use today. Additionally, the preferred embodiment utilizes no fan. Therefore, a very simple yet effective merchandiser has been developed which imparts in a customer a feeling that the displayed bread has been recently baked, thereby enticing the customer to purchase the bread and accordingly, increasing the sales of such bread products.

In the foregoing description, it will be readily appreciated by those skilled in the art that modifications may be made to the invention without departing from the concepts disclosed herein. Such modifications are to be considered as included in the following claims, unless these claims by their language expressly state otherwise.

1. A merchandiser for elongate loaves of fresh baked bread and the like, comprising:
an open rack having a generally vertically extending rear wall, a generally vertically extending front wall spaced apart a predetermined distance from said rear wall, a pair of generally vertically extending sidewalls disposed vertically between said rear wall and said front wall along opposite sides thereof, and a generally horizontally extending bottom wall disposed horizontally between said rear wall, said sidewalls and said front wall along lower portions thereof; said bottom wall having at least one opening to permit the vertical flow of air therethrough, and being configured to abuttingly support thereon ends of elongate bread loaves, such that a plurality of the bread loaves are removably retained between said rear wall, said front wall and said sidewalls in a generally vertical, freestanding, side-by-side relationship;
a base having a lower portion thereof shaped for abutting support on an associated floor surface, an upper portion thereof supporting said open rack thereon, and a generally enclosed interior; and
a heater disposed in the interior of said base, and selectively heating the air disposed therein, such that air heated in the interior of said base flows upwardly through said opening in said bottom wall of said rack, through said open rack, along opposite sides of the vertically stacked bread loaves to maintain the fresh baked smell and feel of the bread loaves.

2. A merchandiser as set forth in claim 1, wherein:
said heater comprises an electrical resistant heater sized to heat the air flowing through the vertically stacked bread loaves to a temperature in the range of 90-100 degrees Fahrenheit to alleviate premature drying of the bread loaves.

3. A merchandiser as set forth in claim 2, wherein:
said front wall has a height that is substantially less than the height of said rear wall to permit easy withdrawal of the bread loaves from an upper portion of said open rack.

4. A merchandiser as set forth in claim 3, wherein:
said bottom wall of said open rack is constructed from a plurality of laterally spaced apart, horizontally extending slats.

5. A merchandiser as set forth in claim 4, wherein:
said opening comprises a plurality of elongate slots defined between said slats.

6. A merchandiser as set forth in claim 5, wherein:
said rear wall of said open rack is constructed from a plurality of vertically spaced apart, horizontally extending slats.

7. A merchandiser as set forth in claim 6, wherein:
said front wall of said open rack is constructed from a plurality of vertically spaced apart, horizontally extending slats.

8. A merchandiser as set forth in claim 7, wherein:
said sidewalls of said open rack are constructed from a plurality of vertically spaced apart, horizontally extending slats.

9. A merchandiser as set forth in claim 8, wherein:
said slats are constructed from wood.

10. A merchandiser as set forth in claim 9, wherein:
said heater is without a fan, such that heated air in said base flows through said open rack solely through convection.

11. A merchandiser as set forth in claim 10, wherein:
said slats in said rear wall are spaced apart more closely at the lower portion thereof than at an upper portion thereof to deflect the heated air upwardly through the vertically oriented bread loaves retained in said open rack.

12. A merchandiser as set forth in claim 11, wherein:
said base is box-shaped and includes a generally open bottom.

13. A merchandiser as set forth in claim 12, wherein:
said base includes a generally open top disposed below said bottom wall of said open rack.

14. A merchandiser as set forth in claim 13, wherein:
said base includes a plurality of wheels to rollingly support the merchandiser.

15. A method of merchandising elongate loaves of bread and the like, comprising:
providing a merchandiser having an open rack with a generally vertical rear wall, a generally vertical front wall, a pair of generally vertical side walls and a bottom wall with at least one opening to permit the vertical flow of air therethrough, and a base with a generally closed interior to support said open rack, and a heater disposed in the interior of said base;
providing a plurality of elongate fresh baked loaves of bread;
stacking the loaves of bread vertically in the open rack;
positioning the merchandiser in a location visible to a customer; and
actuating the heater to maintain the temperature of the loaves of bread in the merchandiser at a temperature not to exceed 120 degrees to retain the fresh baked smell and feel of the bread loaves.

16. The method of merchandising according to claim 15, wherein said positioning step comprises locating the merchandiser adjacent a checkout counter of a retail store.

17. A method of merchandising as set forth in claim 15, wherein said providing step includes providing an electrically resistant heater which heats the air flowing through the vertically stacked bread loaves to a temperature in the range of 90-100 degrees Fahrenheit.

18. A method of merchandising as set forth in claim 17, wherein said providing step includes providing the front wall with a height that is substantially less than the height of the rear wall to permit easy withdrawal of the bread loaves from an upper portion of said open rack.

19. A method of merchandising as set forth in claim 18, wherein said providing step includes providing the bottom wall of the open rack with a plurality of laterally spaced apart, horizontally extending slats.

20. A method of merchandising as set forth in claim 19, wherein said providing step includes defining the at least one opening as a plurality of elongate slots between the slats.

21. A method of merchandising as set forth in claim 20, wherein said providing step includes constructing the rear wall of the open rack from a plurality of vertically spaced apart, horizontally extending slats.

22. A method of merchandising as set forth in claim 21, wherein said providing step includes constructing the front wall of the open rack from a plurality of vertically spaced apart, horizontally extending slats.

23. A method of merchandising as set forth in claim 22, wherein said providing step includes constructing the sidewalls of the open rack from a plurality of vertically spaced apart, horizontally extending slats.

24. A method of merchandising as set forth in claim 23, wherein said providing step includes providing slats constructed from wood.

25. A method of merchandising as set forth in claim 24, wherein said actuating step includes actuating the heater and moving the air in the base convectively.

26. A method of merchandising as set forth in claim 25, wherein said providing step includes providing slats in the rear wall which are spaced apart more closely at a lower portion thereof than at an upper portion thereof.

27. A method of merchandising as set forth in claim 26, wherein said providing step includes providing the base with a box-shape which includes a generally open bottom.

28. A method of merchandising as set forth in claim 27, wherein said providing step includes providing the base with a generally open top disposed below the bottom wall of the open rack.

29. A method of merchandising as set forth in claim 28, wherein said providing step includes providing the base with a plurality of wheels to rollingly support the merchandiser.
